(19) United States
(12) Patent Application Publication
(10) Pub. No.: US 2017/0125814 A1
(43) Pub. Date: May 4, 2017

(54) ELECTRODE HAVING AN ACTUATING BINDER

(71) Applicant: Nissan North America, Inc., Franklin, TN (US)

(72) Inventor: RAMESHWAR YADAV, Novi, MI (US)

(21) Appl. No.: 14/928,533

(22) Filed: Oct. 30, 2015

(51) Int. Cl. H01M 4/62; H01M 4/38; H01M 10/0525; H01M 4/134

(52) U.S. Cl. CPC H01M 4/621; H01M 4/623; H01M 4/134; H01M 4/386; H01M 4/387; H01M 4/38; H01M 10/0525; H01M 2004/027

(57) ABSTRACT

An anode for a lithium ion battery has a current collector, and an active material layer on the current collector, the active material layer comprising alloying particles having high specific capacities, graphite and an actuating binder configured to be conductive when actuated, maintaining conductive contact between the alloying particles and the graphite. The actuating binder comprises a piezoelectric material configured to be actuated with mechanical stress. Alternatively, the actuating binder comprises a pyroelectric material configured to be actuated with heat.

### TECHNICAL FIELD

This disclosure relates to an electrode having an actuating binder that is conductive when actuated.

### BACKGROUND

Hybrid vehicles (HEV) and electric vehicles (EV) use chargeable-dischargeable power sources. Secondary batteries such as lithium-ion batteries are typical power sources for HEV and EV vehicles. Lithium-ion secondary batteries typically use carbon, such as graphite, as the anode electrode. Graphite materials are very stable and exhibit good cycle-life and durability. However, graphite material suffers from a low theoretical lithium storage capacity of only about 372 mAh/g. This low storage capacity results in poor energy density of the lithium-ion battery and low electric mileage per charge.

To increase the theoretical lithium storage capacity, silicon has been added to active materials. However, silicon active materials suffer from rapid capacity fade, poor cycle life and poor durability. One primary cause of this rapid capacity fade is the massive volume expansion of silicon (typically up to 300%) upon lithium insertion. Volume expansion of silicon causes particle cracking and pulverization. This deteriorative phenomenon escalates to the electrode level, leading to electrode delamination, loss of porosity, electrical isolation of the active material, increase in electrode thickness, rapid capacity fade and ultimate cell failure.

### SUMMARY

Disclosed herein are anodes for a lithium ion battery having an actuating binder. One embodiment of an anode for a lithium ion battery comprises a current collector, and an active material layer on the current collector, the active material layer comprising alloying particles having high specific capacities, graphite and an actuating binder configured to be conductive when actuated, maintaining conductive contact between the alloying particles and the graphite.

In one embodiment, the actuating binder comprises a piezoelectric material configured to be actuated with mechanical stress. In another embodiment, the actuating binder comprises a pyroelectric material configured to be actuated with heat.

Also disclosed are lithium ion batteries comprising the anodes disclosed herein.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 is a schematic of an anode for a lithium ion battery as disclosed herein; and

FIG. 2 is a schematic of the anode for a lithium ion battery as disclosed herein with the alloying particles in a lithiated, or expanded, state.

### DETAILED DESCRIPTION

Because the carbon material used in electrodes of conventional batteries, such as lithium ion batteries or sodium ion batteries, suffers from a low specific capacity, the conventional battery has poor energy density even though there is small polarization and good stability. Furthermore, batteries having electrodes of graphite or other carbon materials develop increased internal resistance over time, which decreases their ability to deliver current.

To address the poor energy density of carbon based electrodes, alternative active materials with higher energy densities are desired. Alloying particles such as silicon, tin, germanium and their oxides and alloys are non-limiting examples of materials that may be added to an electrode active material layer to improve its energy density, among other benefits.

One particular example is the use of silicon in lithium-ion batteries. Electrode materials such as silicon react with lithium via a different mechanism than graphite. Lithium forms alloys with silicon materials, which involves breaking the bonds between host atoms, causing dramatic structural changes in the process. Since the silicon does not constrain the reaction, anode materials that form alloys can have much higher specific capacity than intercalation electrode materials such as graphite. Silicon based anode active materials have potential as a replacement for the carbon material of conventional lithium-ion battery anodes due to silicon's high theoretical lithium storage capacity of 3500 to 4400 mAh/g. Such a high theoretical storage capacity could significantly enhance the energy density of the lithium-ion batteries. However, silicon active materials suffer from rapid capacity fade, poor cycle life and poor durability. One primary cause of this rapid capacity fade is the massive volume expansion of silicon (typically up to 300%) and structural changes due to lithium insertion. Volume expansion of silicon can cause particle cracking and pulverization when the silicon has no room to expand, which leads to delamination of the active material from the current collector, electrical isolation of the fractured or pulverized active material, capacity fade due to collapsed conductive pathways, increased internal resistance over time, etc.

Disclosed herein are anodes for lithium ion batteries configured to reduce electrical isolation of active particles that alloy with lithium, maintaining the electrical contact between alloying particles and graphite in the active material layer.

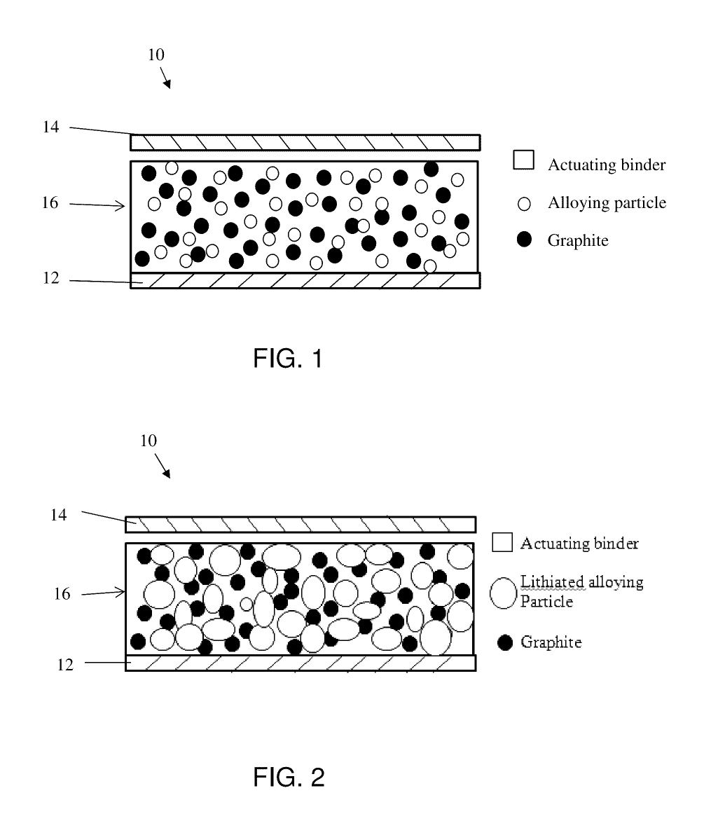

FIG. 1 is a schematic illustration of an anode 10 for a lithium ion battery comprising a current collector 12, a separator 14 and an active material layer 16 coated on the current collector 12. The active material layer 16 has alloying particles having high specific capacities, graphite and an actuating binder configured to be conductive when actuated, maintaining conductive contact between the alloying particles and the graphite. The actuating binder has an unactivated state when the lithium ion battery is not in use, and an activated state when the lithium ion battery is charging and discharging.

As used herein, “alloying particles having high specific capacities” refers to particles such as silicon, tin, germanium and other materials that alloy with lithium, resulting in large volume expansion due to the capacity for lithium.

One example of the actuating binder is a piezoelectric binder. The alloying particles have an expanded state during lithiation, illustrated in FIG. 2, and a non-expanded state during delithiation, illustrated in FIG. 1. The piezoelectric material of the binder is actuated by mechanical stress caused by the expansion and contraction of the alloying particles. The change in pressure in the active material layer 16 experienced by the piezoelectric binder activates the piezoelectric binder, rendering the piezoelectric material conductive. When the anode 10 is not in use, the piezoelectric binder is not activated and is non-conductive. The piezoelectric binder can be polyvinylidene fluoride, polyvinylidene fluoride composite, polyvinylidene fluoride-trifluoroethylene copolymer, lithium niobate, Parylene-C, zinc oxide, barium titanate, a combination of these, or any other similar piezoelectric material known to those skilled in the art.

The piezoelectric binder, when activated, provides conductive pathways through the anode and maintains conductive connection between the graphite and alloying particles, even as the alloying particles degrade due to repeated expansion and contraction. The piezoelectric binder also maintains contact between the active materials and the current collector, reducing the effects of delamination between alloying particles and the current collector.

Another example of the actuating binder is a pyroelectric binder. The alloying particles have an expanded state during lithiation, illustrated in FIG. 2, and a non-expanded state during delithiation, illustrated in FIG. 1. The pyroelectric binder is actuated by heat, such as that created due to the expansion and contraction of the alloying particles, as well as the heat generated by the internal resistance and normal battery cycling. The increase in heat in the active material layer 16 experienced by the pyroelectric binder activates the pyroelectric binder, rendering the pyroelectric material conductive. When the anode 10 is not in use, the pyroelectric binder is not activated and is non-conductive. The piezoelectric binder can be lithium tantalate or any other similar piezoelectric material known to those skilled in the art. Furthermore, piezoelectric and pyroelectric binders can be combined in the active material layer 16.

The pyroelectric binder, when activated, provides conductive pathways through the anode and maintains conductive connection between the graphite and alloying particles, even as the alloying particles degrade due to repeated expansion and contraction. The pyroelectric binder also maintains contact between the active materials and the current collector, reducing the effects of delamination between alloying particles and the current collector.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An anode for a lithium ion battery comprising:
a current collector; and
an active material layer on the current collector, the active material layer comprising:
alloying particles having high specific capacities;
graphite; and
an actuating binder configured to be conductive when actuated, maintaining conductive contact between the alloying particles and the graphite.

2. The anode of claim 1, wherein the actuating binder is one or more of polyvinylidene fluoride, polyvinylidene fluoride composite, polyvinylidene fluoride-trifluoroethylene copolymer, lithium niobate, Parylene-C, zinc oxide, barium titanate, or a combination of these.

3. The anode of claim 1, wherein the actuating binder comprises a piezoelectric material configured to be actuated with mechanical stress.

4. The anode of claim 3, wherein the actuating binder has an unactivated state when the lithium ion battery is not in use, and an activated state when the lithium ion battery is charging and discharging.

5. The anode of claim 3, wherein the alloying particles have an expanded state during lithiation and a non-expanded state during delithiation, the piezoelectric material of the binder in a conductive state due to activation by mechanical stress caused by the expanded state and the unexpanded state of the alloying particles.

6. The anode of claim 5, wherein the alloying particles comprise one or more of silicon, tin and germanium.

7. The anode of claim 3, wherein the piezoelectric material is one or both of polyvinylidene fluoride and lithium niobate.

8. A lithium ion battery comprising the anode of claim 3.

9. The anode of claim 1, wherein the actuating binder comprises a pyroelectric material configured to be actuated with heat.

10. The anode of claim 9, wherein the binder has an unactivated state when the lithium ion battery is cool do to non-use or little use, and an activated state when the lithium ion battery is heated due to charging and discharging.

11. The anode of claim 9, wherein the alloying particles have an expanded state during lithiation and a non-expanded state during delithiation, the pyroelectric material of the binder in a conductive state due to activation by heat caused by charging and discharging.

12. The anode of claim 9, wherein the alloying particles comprise one or more of silicon, tin and germanium.

13. The anode of claim 9, wherein the pyroelectric material is lithium tantalate.

14. A lithium ion battery comprising the anode of claim 9.
